(19) United States
(12) Patent Application Publication
(10) Pub. No.: US 2014/0185850 A1
(43) Pub. Date: Jul. 3, 2014

(54) METHOD AND APPARATUS FOR TONAL ENHANCEMENT IN HEARING AID

(71) Applicant: STARKEY LABORATORIES, INC., Eden Prairie, MN (US)

(72) Inventors: Kelly Fitz, Eden Prairie, MN (US); Martin McKinney, Minneapolis, MN (US)

(73) Assignee: Starkey Laboratories, Inc., Eden Prairie, MN (US)

(21) Appl. No.: 13/732,868

(22) Filed: Jan. 2, 2013

(51) Int. Cl. H04R 25/00

(52) U.S. Cl. CPC H04R 25/50
USPC 381/320

(57) ABSTRACT

An audio processing circuit tracks tonal components in an audio stream and enhances them by synthesizing matching tones, processing the matched tones, and mixing them in with the audio stream. A hearing assistance device, for example a hearing aid, includes such an audio processing circuit for enhancing the pitched or tonal parts of tonal sound such as speech or music.

### TECHNICAL FIELD

This document relates generally to hearing assistance systems and more particularly to a hearing assistance device, such as a hearing aid, that provides for tonal enhancement.

### BACKGROUND

Hearing assistance devices include a variety of devices such as assistive listening devices, cochlear implants and hearing aids. Hearing aids are useful in improving the hearing and speech comprehension of people who have hearing loss by selectively amplifying certain frequencies according to the hearing loss of the subject. A hearing aid typically includes a microphone, an amplifier and a receiver (speaker). The microphone receives sound (acoustic signal) and converts it to an electrical signal and sends it to the amplifier. The amplifier increases the power of the signal, in proportion to the hearing loss, and then sends it to the ear through the receiver. Cochlear devices may employ electrodes to transmit sound to the patient.

A tonal language such as Chinese (Mandarin or Cantonese) or Thai is unlike English, because it relies on pitch discrimination for speech intelligibility. For example, Mandarin Chinese uses four tones to clarify the meanings of words: a first tone at a high level, a second rising tone, a third falling then rising tone, and a fourth falling tone. Since many characters have the same sound, tones are used to differentiate words from each other. The tones are discriminated by the pitch changes which are often limited to a small range in the low frequency spectrum.

For hearing-impaired listeners, even with the aid of a hearing assistance device, the pitch detection rate could drop due to insufficient spectrum resolution and hearing loss in low frequencies. This leads to poor speech intelligibility of a tonal language for a wearer of a hearing assistance device. Music, particularly multi-instrumental music, is another example of a tonal sound signal. The decreased pitch detection rate causes unsatisfactory perception of music. Thus, there is a need for tonal enhancement for hearing assistance devices.

### SUMMARY

An audio processing circuit tracks tonal components in an audio stream and enhances them by synthesizing matching tones, processing the matched tones, and mixing them in with the audio stream. A hearing assistance device, for example a hearing aid, includes such an audio processing circuit for enhancing the pitched or tonal parts of tonal sound such as speech or music.

In one embodiment, a hearing assistance device includes a microphone to receive an acoustic signal including original tonal components, a receiver to receive an output audio signal and transmit an output sound representing the output audio signal, and a processing circuit coupled between the microphone and the receiver. The processing circuit includes a tonal enhancement circuit configured to extract the tonal components from the acoustic signal, enhance the extracted tonal components, and mix the enhanced tonal components with the acoustic signal including the original tonal components to produce the output audio signal. In one embodiment, the tonal enhancement circuit includes an analyzer, a synthesizer, and a mixer. The analyzer is configured to perform sinusoidal analysis of the acoustic signal to identify harmonics of tonal components in the acoustic signal. The synthesizer is configured to synthesize the harmonics of the tonal components. The mixer is configured to mix the synthesized harmonics with the acoustic signal including the original tonal components to produce the output audio signal.

In one embodiment, a method for operating a hearing assistance device is provided. An acoustic signal including original tonal components is received. The tonal components are identified from the acoustic signal. The identified tonal components are enhanced. The enhanced tonal components are mixed with the acoustic signal including the original tonal components to produce an output audio signal.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 is a block diagram illustrating an embodiment of a hearing assistance device providing for tonal enhancement.

FIG. 2 is a block diagram illustrating an embodiment of a tonal enhancement circuit.

FIG. 3 is a block diagram illustrating another embodiment of the tonal enhancement circuit.

FIG. 4 is a block diagram illustrating an embodiment of a processing circuit of the hearing assistance device.

FIG. 5 is a flow chart illustrating an embodiment of a method for enhancing tonal components of an acoustic signal.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

This document discusses an apparatus and method for enhancing pitch salience in a hearing assistance device such as a hearing aid. The need for enhancing pitch salience or tonal parts of speech has been demonstrated in efforts of improving hearing aid performance associated with tonal signals, including tonal languages (such as Chinese) and music. The present system and method enhance the pitched or tonal parts of a speech or music signal to improve auditory streaming by a hearing loss patient in complex acoustic environments with many sound sources, such multi-talker speech environments or multi-instrumental music. In the present document, a tonal signal includes a sound whose intelligibility substantially depends on audibility of its tones.

Fundamental frequency enhancement has been applied as a front-end process in automatic speech recognition technology. Spectral sharpening techniques have been applied to provide formant enhancement. Such approaches do not provide a hearing assistance device with increased pitch saliency or specifically enhanced tonal components of speech or music. The present apparatus tracks tonal components (sinusoids) in an audio stream and enhances them by synthesizing matching (in frequency and amplitude) phase-synchronous tones, processing those matched tones, and mixing them in with the audio stream. In the present apparatus, tonal components of an input acoustic signal is isolated, and then gain and/or other signal processing can be applied to the isolated components to enhance the pitched parts of speech and music. Such tonal enhancement makes the pitched parts of speech and music more audible in the presence of background noise, improves pitch salience, enhances auditory streaming, and makes it easier to hear out individual musical instruments in an ensemble and to separate voices in a noisy environment.

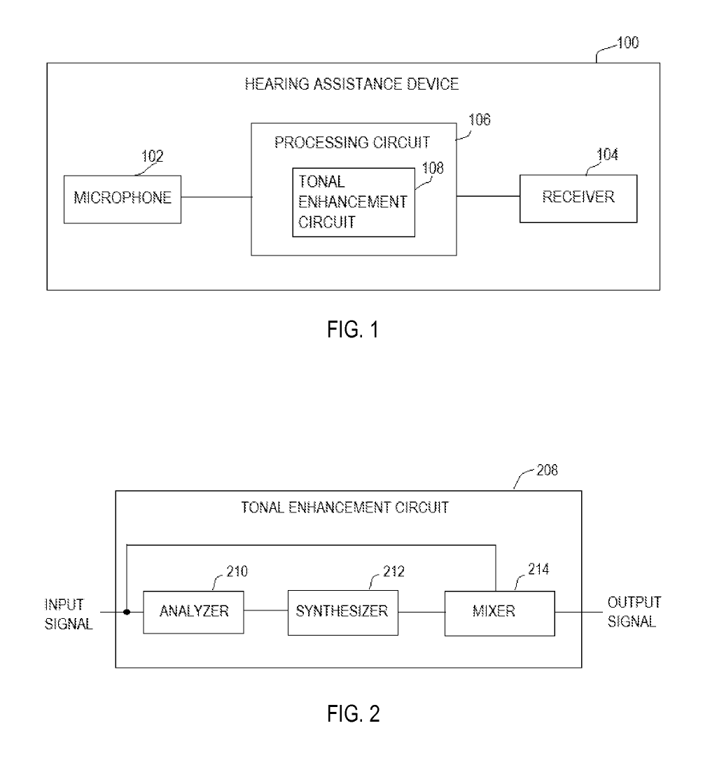

FIG. 1 is a block diagram illustrating an embodiment of a hearing assistance device 100 that provides for tonal enhancement. Device 100 includes a microphone 102, a receiver (speaker) 104, and a processing circuit 106 coupled between the microphone and the receiver. Microphone 102 receives an acoustic signal including tonal components. Receiver 104 receives an output audio signal and transmits an audible output sound representing the output audio signal to be heard by a listener. Processing circuit 106 produces the output audio signal by processing the acoustic signal. Processing circuit 106 includes a tonal enhancement circuit 108 that is configured to extract the tonal components from the acoustic signal, enhance the extracted tonal components, and mix the enhanced tonal components with the acoustic signal to produce the output audio signal. The output audio signal thus includes the original tonal components of the acoustic signal received by microphone 102 and the enhanced tonal components.

In various embodiments, the acoustic signal sensed by microphone 102 and processed by processing circuit 106 can include a tonal sound. The tonal sound includes one or more distinguishable pitches. Examples of tonal sound include speech and music. Examples of tonal components of such tonal sound include vowel parts of speech and pitched parts of music. In various embodiments, receiver 104 is to be paced in or near an ear canal of the listener to transmit the output audio signal to the listener's ear canal(s).

In one embodiment, device 100 includes a hearing aid for use by a patient suffering hearing loss. Processing circuit 106 produces the output audio signal by processing the acoustic signal in real time. Tonal enhancement circuit 108 provides device 100 with capability of enhancing the pitched or tonal parts of speech and/or music to improve auditory streaming by the hearing loss patient.

In various embodiments, the circuit of device 100, including its various elements discussed in this document, is implemented using hardware, software, or a combination of hardware and software. In various embodiments, processing circuit 106, including its various elements, may be implemented using one or more circuits specifically constructed to perform one or more functions discussed in this document or one or more general-purpose circuits programmed to perform such one or more functions. Examples of such general-purpose circuit can include a microprocessor or a portion thereof, a microcontroller or portions thereof, and a programmable logic circuit or a portion thereof.

FIG. 2 is a block diagram illustrating an embodiment of a tonal enhancement circuit 208. Tonal enhancement circuit 208 represents an embodiment of tonal enhancement circuit 108 and includes an analyzer 210, a synthesizer 212, and a mixer 214. The input signal to tonal enhancement circuit 208 is an acoustic signal with tonal components. In various embodiments, the input signal includes the acoustic signal sensed by microphone 102. In various embodiments, the input signal includes a conditioned acoustic signal such as the acoustic signal sensed by microphone 102 and pre-conditioned by amplification and/or filtering. The output signal from tonal enhancement circuit 208 includes an audio signal such as the output audio signal to be received by receiver 104. In one embodiment, the output signal is further processed by processing circuit 106 to produce the output audio signal. In various embodiments, tonal enhancement circuit 208 produces the output signal by increasing pitch saliency and/or enhancing the pitched parts of the input signal.

Analyzer 210 is configured to perform sinusoidal analysis of the input signal to identify harmonics of the tonal components in the input signal. Harmonics are characterized by their time-varying frequencies, amplitudes, and phases. Harmonics may include the fundamental frequency (sometimes referred to as the first harmonic). In various embodiments, analyzer 210 extracts the tonal components from the input signal by performing sinusoidal analysis of the input signal to identify and analyze harmonics of the tonal components in the input signal. In various embodiments, at least the fundamental frequencies are identified. In one embodiment, analyzer 210 performs the sinusoidal analysis in real time.

Synthesizer 212 is configured to enhance the identified harmonics of the tonal components by at least synthesizing the harmonics. In various embodiments, synthesizer 212 synthesizes the identified harmonics of the tonal components as frequency-and-phase-synchronous sinusoids. In various embodiments, synthesizer 212 enhances the harmonics of the tonal components, such as by amplifying the synthesized harmonics. In various embodiments, synthesizer 212 may perform additional types of enhancement such as dynamic range compression or frequency transposition. In various embodiments, various types of enhancement may be applied before and/or after the synthesis of the harmonics. For example, it may be computationally advantageous to perform the enhancement in the analysis domain, operating on the sinusoidal parameters, before synthesizing the harmonics. In various embodiments, by extracting the tonal components from the input signal and synthesizing only the tonal components for enhancement, harmonics of speech and/or music can be enhanced to improve the local signal-to-noise ratio (SNR). This is not possible using gain-based processing of the acoustic signal alone.

Mixer 214 is configured to mix the synthesized harmonics with the input signal to produce the output audio signal. The input signal includes the “original” tonal components including their harmonics as received by microphone 102. Thus, synthesized sound is used to enhance an audio stream by being mixed into the input signal, rather than replacing the input signal or parts of the input signal, thereby reducing the audibility of artifacts from synthesis.

In various embodiments, such as when tonal enhancement circuit 208 is used in a hearing aid, analyzer 210, synthesizer 212, and mixer 214 perform their functions in real-time. However, tonal enhancement circuit 208 may also be used to process recorded acoustic signals, for example, in various other embodiments.

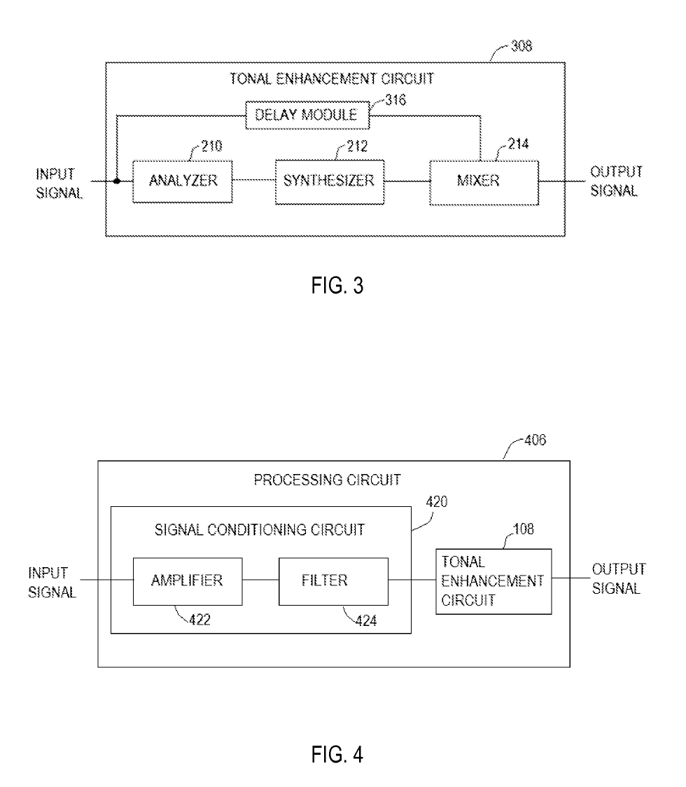

FIG. 3 is a block diagram illustrating an embodiment of a tonal enhancement circuit 308, which represents another embodiment of tonal enhancement circuit 108. Tonal enhancement circuit 308 includes analyzer 210, synthesizer 212, mixer 214, and a delay module 420. In other words, tonal enhancement circuit 308 includes elements of tonal enhancement circuit 208 with the additional delay module 316. The input to signal to tonal enhancement circuit 308 is an acoustic signal with tonal components, and the output signal from tonal enhancement circuit 308 includes an audio signal such as the output audio signal to be received by receiver 104, as discussed above with reference to FIG. 2. In one embodiment, the output signal is further processed by processing circuit 106 to produce the output audio signal. In various embodiments, tonal enhancement circuit 208 produces the output signal by increasing pitch saliency and/or enhancing the pitched parts of the input signal.

Delay module 316 applies a delay to the input signal before it is mixed with the synthesized harmonics by mixer 214. The delay compensates for processing latency of the tonal enhancement process in analyzer 210 and synthesizer 212, when such compensation is deemed necessary or beneficial.

In various embodiments, tonal enhancement circuit 308 includes a processing module that processes the input signal independently from analyzer 210 and synthesizer 212, in additional to or in place of delay module 316. In other words, the input signal may be processed in any way deemed necessary or appropriate by those skilled in the art before it is mixed with the synthesized harmonics by mixer 214.

FIG. 4 is a block diagram illustrating an embodiment of a processing circuit 406, which represents an embodiment of processing circuit 106. In the illustrated embodiment, processing circuit 406 includes a signal conditioning circuit 420 in addition to tonal enhancement circuit 108, which in various embodiments may include tonal enhancement circuit 208 or 308. Signal conditioning circuit 420 may include an amplifier 422 to amplify the input signal and/or a filter 424 to filter the input signal. The input signal to processing circuit 406 is an acoustic signal with tonal components, such as the acoustic signal sensed by microphone 102. The output signal from processing circuit 406 includes an audio signal such as the output audio signal to be received by receiver 104. In one embodiment, processing circuit 406 further processes the signal produced by tonal enhancement circuit 108 to produce the output audio signal. In one embodiment, signal conditioning circuit 420 produces a conditioned acoustic signal that is the input signal to tonal enhancement circuit 208 or 308.

In various embodiments of device 100, by extracting only the strongly tonal components, and mixing the enhanced tonal components (e.g., sinusoids) with the acoustic signal including the original tonal components, audible artifacts sometimes associated with sinusoidal synthesis (of speech for example) are reduced (masked) or eliminated. Such artifacts are most often produced by poor representation of non-tonal parts of the signal, which are not captured when only the tonal parts are enhanced. Another source of artifacts is incomplete representation of the tonal parts (capturing too few harmonics, for example). By mixing the enhanced tonal components (e.g., sinusoids) with the acoustic signal including the original tonal components, device 100 enhances the most prominent harmonics (because they are the easiest to capture). The weaker harmonics that are not captured are still present in the acoustic signal including the original tonal components, so they are not absent, though not enhanced, in the output audio signal. This represents an advantage of the present system and method.

In various embodiments of device 100, the pitched parts of speech and music are enhanced by synthesizing the high-energy low harmonics, applying gain or other signal processing to this synthetic signal, and adding it to the unprocessed acoustic signal. By processing only the synthesized harmonics, enhancements that are far beyond what is possible with channel-based signal enhancement is achievable because the synthesized harmonics (unlike the harmonics in the unprocessed signal) have effectively infinite SNR.

In addition to improving the overall SNR, enhancing the low, resolved harmonics of speech and music makes the pitch of those signals more salient, thus enhancing auditory streaming (since pitch contributes to the ability of forming and following auditory streams). This enables or makes it easier for the listener to hear out individual musical instruments in an ensemble and separate voices in multi-talker situations.

When device 100 is implemented as a hearing aid, real time processing constraints include very low latency on the order of a few milliseconds. The presents challenges for accurate frequency estimation. For streaming audio applications, on the other hand, the real time constraints can be relaxed to certain extent, as it may be possible to tolerate higher latency. Construction of complete and accurate sinusoidal models of complex sounds generally requires a lot of computing power, and generates a lot of data. However, an incomplete model of only the strongest harmonics in the most stable pitched sounds can be constructed at a much lower cost. Synthesizing only such strongest harmonics and mixing them with the unprocessed acoustic signal generally does not require a complete high-fidelity sinusoidal model in practice. On the other hand, the captured harmonic components need to be very accurate in their phase and frequency estimates so that they can be mixed with the unprocessed sound without introducing artifacts due to destructive interference. It is noted that in many common applications, phase accuracy is considered to be of secondary importance.

In various embodiments of device 100, a key feature of the sinusoidal analysis is a confidence measure, or sinusoidality measure, that allows selection of only the strongest, most tonal components. Examples of such measures are discussed in S. A. Fulop and K. Fitz, “Separation of components from impulses in reassigned spectrograms,” Journal of the Acoustical Society of America, vol. 121, no. 3, pp. 1510-1518, 2007. The need for the confidence measure is related to the need for the highly accurate and reliable phase and frequency estimates.

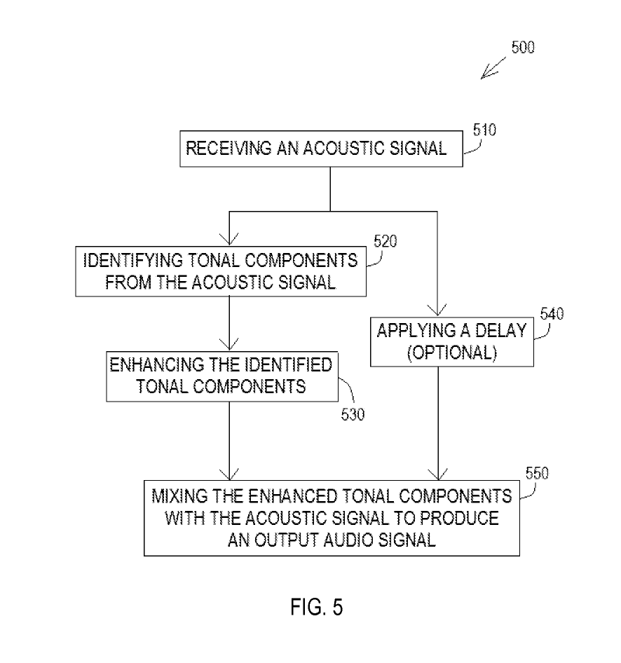

FIG. 5 is a flow chart illustrating an embodiment of a method 500 for enhancing tonal components of an acoustic signal. In various embodiments, method 500 is applied to operate a hearing assistance device such as device 100, including the various embodiments of its elements, as discussed in this document. An example of such a hearing assistance device includes a hearing aid, in which method 500, including each of its steps as illustrated in FIG. 5 and discussed below, is performed in real time.

At 510, an acoustic signal is received. The acoustic signal includes original tonal components (i.e., tonal components that are part of a sound of interest rather than synthesized to assist hearing of that sound). At 520, the tonal components are identified from the acoustic signal. In various embodiments, only tonal components meeting specified criterion or threshold are identified. In one embodiment, a sinusoidal analysis is performed to identify harmonics of the tonal components. At 530, the identified tonal components are enhanced. In various embodiments, this includes synthesizing the identified harmonics and enhancing the harmonics. In one embodiment, the synthesized identified harmonics are amplified. In various embodiments, the enhancement may include other signal processing before or after synthesizing the identified harmonics. Optionally at 540, a delay is applied to the acoustic signal including the original tonal components to compensate for the latency associated with steps 520 and 530. At 550, the enhanced tonal components are mixed with the acoustic signal including the original tonal components to produce an output audio signal. If the delay is applied to the acoustic signal at 550, the enhanced tonal components are mixed with the delayed acoustic signal. In various embodiments, one or more processing techniques may be applied to the acoustic signal, in additional to or in place of the delay, before the enhanced tonal components are mixed with the acoustic signal. The output audio signal is converted to an audible output sound to be transmitted to an ear canal of a listener.

In various embodiments, in addition to a hearing aid, method 500 may be applied in an outboard device such as a cellphone/multimedia streamer or television streamer. In a streaming implementation, the computational burden can be offloaded to the streamer, and additional latency (due to communication, as well as computation) can be tolerated, particularly if video delay can be implemented to keep the audio and video synchronized for movie and television viewing, because of the absence of a direct acoustic path to the ear canal (the signal exists only electronically). In a mobile (non-streaming) application, it may be possible to offload some of the computation to a remote device such as like the cellphone/multimedia streamer. For example, signal analysis may be performed by the remote device to identify harmonics and estimate their frequencies (by time-frequency or Fourier domain processing), thus leaving only the phase estimation to be performed by the hearing aid.

The present subject matter is demonstrated for hearing assistance devices, including hearing aids, including but not limited to, behind-the-ear (BTE), in-the-ear (ITE), in-the-canal (ITC), receiver-in-canal (RIC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices. It is understood that other hearing assistance devices not expressly stated herein may be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A hearing assistance device, comprising:
a microphone configured to receive an acoustic signal including original tonal components;
a receiver configured to receive an output audio signal and transmit an output sound representing the output audio signal;
a processing circuit coupled between the microphone and the receiver, the processing circuit including a tonal enhancement circuit configured to extract the tonal components from the acoustic signal, enhance the extracted tonal components, and mix the enhanced tonal components with the acoustic signal including the original tonal components to produce the output audio signal.

2. The hearing assistance device of claim 1, comprising a hearing aid including the microphone, the receiver, and the processing circuit.

3. The hearing assistance device of claim 1, wherein the tonal enhancement circuit is configured to identify harmonics of the tonal components in the acoustic signal, synthesize the identified harmonics, and mix the synthesized identified harmonics with the acoustic signal to produce the output audio signal.

4. The hearing assistance device of claim 3, wherein the tonal enhancement circuit is further configured to amplify the synthesized identified harmonics.

5. The hearing assistance device of claim 4, wherein the tonal enhancement circuit is further configured apply a delay to the acoustic signal and mix the synthesized identified harmonics with the delayed acoustic signal to produce the output audio signal.

6. The hearing assistance device of claim 3, wherein the hearing aid is configured as a behind-the-ear (BTE) hearing aid.

7. The hearing assistance device of claim 3, wherein the hearing aid is configured as an in-the-ear (ITE) hearing aid.

8. The hearing assistance device of claim 7, wherein the hearing aid is configured as an in-the-canal (ITC) hearing aid.

9. A hearing assistance device, comprising:
a microphone configured to receive an acoustic signal including original tonal components;
a receiver configured to receive an output audio signal and transmit an output sound representing the output audio signal;
a processing circuit coupled between the microphone and the receiver, the processing circuit including a tonal enhancement circuit including:
an analyzer configured to perform sinusoidal analysis of the acoustic signal to identify harmonics of tonal components in the acoustic signal;
a synthesizer configured to synthesize the harmonics of the tonal components; and
a mixer configured to mix the synthesized harmonics with the acoustic signal including the original tonal components to produce the output audio signal.

10. The hearing assistance device of claim 9, wherein the processing circuit is configured to produce the output audio signal using the acoustic signal in real time.

11. The hearing assistance device of claim 10, comprising a hearing aid including the microphone, the receiver, and the processing circuit.

12. The hearing assistance device of claim 9, wherein the synthesizer is further configured to enhance the synthesized harmonics of the tonal components.

13. The hearing assistance device of claim 12, wherein the processing circuit further comprises a signal conditioning circuit configured to condition the acoustic signal, and the mixer is configured to mix the enhanced synthesized harmonics with the conditioned acoustic signal to produce the output audio signal.

14. The hearing assistance device of claim 13, wherein the tonal enhancement circuit further comprises a delay module configured to apply a delay to the conditioned acoustic signal, and the mixer is configured to mix the enhanced synthesized harmonics with the delayed conditioned acoustic signal to produce the output audio signal.

15. The hearing assistance device of claim 14, wherein the synthesizer is configured to amplify the synthesized harmonics of the tonal components.

16. A method for operating a hearing assistance device, comprising:
receiving an acoustic signal including original tonal components;
identifying the tonal components from the acoustic signal;
enhancing the identified tonal components;
mixing the enhanced tonal components with the acoustic signal including the original tonal components to produce an output audio signal.

17. The method of claim 16, further comprising transmitting an output sound representing the output audio signal to an ear canal of a listener wearing a hearing aid.

18. The method of claim 17, wherein identifying the tonal components from the acoustic signal comprises performing a real-time sinusoidal analysis to identify harmonics of the tonal components, and enhancing the identified tonal components comprises synthesizing the identified harmonics.

19. The method of claim 18, wherein enhancing the identified tonal components further comprises amplifying the synthesized identified harmonics.

20. The method of claim 18, further comprising applying a delay to the acoustic signal including the original tonal components, and wherein mixing the enhanced tonal components with the acoustic signal including the original tonal components comprises mixing the synthesized identified harmonics with the delayed acoustic signal.
